(19) United States
(12) Patent Application Publication
(10) Pub. No.: US 2002/0069411 A1
(43) Pub. Date: Jun. 6, 2002

(54) Enhanced display of world wide web pages on television

(75) Inventors: Mario Rainville, Doylestown, PA (US); Vipul Patel, Langhorne, PA (US)

Correspondence Address: ALLAN J JACOBSON, 13310 SUMMIT SQUARE CENTER, RTE 413 & DOUBLEWOODS RD, LANGHORNE, PA, 19047, US

(73) Assignee: Liberate Technologies, MoreCom Division, Inc.

(21) Appl. No.: 09/731,262

(22) Filed: Dec. 6, 2000

Related U.S. Application Data
(60) Provisional application No. 60/169,766, filed on Dec. 9, 1999.

(51) Int. Cl. H04N 5/445; H04N 7/173

(52) U.S. Cl. 725/37; 725/131; 725/109; 725/110

(57) ABSTRACT

A system for enhancing the display of World Wide Web pages combined with television video signals on a TV screen includes enhanced display modes. In a first embodiment, the viewer controls the transparency of a Picture-In-Picture image (PIP). A PIP image that normally covers up a part of the background image is made transparent so that the user can view the background image through the PIP image. Using transparency control, two same size images are simultaneously viewed whereby a full size background image and a full size foreground image simultaneously occupy the full television video screen. In a second embodiment of enhanced display of television video and World Wide Web graphics, a television video Picture-In-Graphics (PIG) image is imbedded as an object in an HTML Web page. When the HTML Web page is displayed as a background image and scrolled (or panned), the television video PIG image scrolls along with the HTML Web page background image. In such manner, the smaller PIG image does not cover up an important part of the larger background graphics image.

### FIELD OF THE INVENTION

The present invention relates to the combined display of television signals and World Wide Web pages.

### BACKGROUND OF THE INVENTION

It has been proposed to combine various forms of media. In particular, there are proposed systems to combine the World Wide Web (WWW) portion of the Internet and television video. Television video is typically available by terrestrial broadcast, cable and satellite. In addition, other methods of television delivery are known.

The World Wide Web is most commonly available through an Internet service provider over a dial up telephone modem on a plain telephone line. More recently other forms of high speed Internet access (ISDN, ASDL or broadband cable modem and the like) are available. However, while many devices incorporate access to both television media and the Internet, there is still a problem of how to merge the two media (television and WWW Internet) in such manner that the merged media is both useful to the viewer and intuitive to use.

In some cases, a single television screen is shared by switching between television viewing and Internet surfing. For example, a television show may contain a reference to a Web site. The viewer switches the single screen from television viewing to the referenced Web site. After navigating to the referenced Web site and from there to possibly other portions of the World Wide Web, the viewer switches back to watching television. In the alternative, a personal computer monitor used for Internet surfing may also be used for television video viewing.

In other cases, a single screen is shared between simultaneous television viewing and Internet surfing. One method of simultaneous screen sharing is to split the screen such that television viewing is provided in a first portion of the screen and a Web page is viewed in a second portion of the screen. In a special case of screen sharing, the well-known “picture-in-picture” (PIP) format is provided in which a smaller size image is placed within a larger (normal size) background image. Although the smaller PIP image covers up a portion of the larger (full size, full screen) background image, the viewer may be able to avoid covering up an important part of the larger background image by selecting the position and size of the smaller PIP image.

When applied to combining WWW and television video using PIP techniques, the television video image is typically the smaller image and World Wide Web graphics is the background image. The PIP format is sometimes referred to as PIG for “picture-in-graphics”. Both picture-in-graphics and the reverse, graphics-in-picture are included in the term picture-in-picture, or PIP.

In the case of a hypertext markup language (HTML) Web page (graphics) as the background image, and television video as the PIG image, the Web page may be scrolled, while the television video PIG image remains stationary. Thus, if the television video PIG image covers up an important part of the larger HTML background image, the viewer must scroll the HTML background image out from under the television video PIG image or move the PIG image. In general, prior art PIP image displays do not allow simultaneous display of all of two images, TV and WWW graphics, at the same time.

### SUMMARY OF THE INVENTION

In accordance with the present invention, a system for enhancing the display of World Wide Web pages combined with television video on a video screen is provided. In particular, the viewer is provided with control over transparency of a PIP image. In such manner a PIP image, which may normally cover up an important part of the background Web page image, is made transparent so that the user can view the background Web page image through the transparent PIP image. With transparency control, two images having the same size may be simultaneously viewed. A full size background image and a full size foreground image may simultaneously occupy the full television video screen.

In accordance with another aspect of the present invention, a television video PIG image is embedded in an HTML Web page as an object. When the HTML Web page is displayed as a background image and scrolled (or panned), the television video PIG image scrolls along with the HTML Web page background image. In such manner, the smaller PIG image has its own space (or box) on the Web page. The smaller PIG image moves with the Web graphics image and does not cover up an important part of the background Web graphics image. In the latter embedded mode, the PIG image is not just an overlay on top of the web page, but instead is an integral part of the web page.

### BRIEF DESCRIPTION OF THE DRAWINGS

FIG. 1 is a block diagram of a CATV system embodying the present invention.

FIGS. 2A shows a prior art display illustrating an HTML Web page with an opaque television video PIG image on top.

FIGS. 2B and 2C show the prior display of FIG. 2A in which the HTML Web page in the background is scrolled up while the PIG image in the foreground remains at its original position relative to the display screen.

FIG. 3A illustrates an HTML Web page with a transparent television video PIG image on top, in accordance with the present invention.

FIGS. 3B and 3C show the display of FIG. 3A in which the HTML Web page is scrolled up and down while the PIG image in the foreground remains at its original position relative to the display screen, in accordance with the present invention.

FIG. 4A is an illustration of an HTML Web page with a television video PIG image embedded in the HTML Web page, in accordance with the present invention.

FIG. 4B shows the display of FIG. 4A in which the Web page is scrolled up with the PIG image being an integral part of the HTML Web page, in accordance with the present invention.

FIGS. 5a-5e illustrate various transparency modes for picture-in-graphics (PIG) television video overlay on an HTML Web page in accordance with the present invention.

FIG. 6 is a block diagram of the display logic for embedding a television video image within an HTML Web page in accordance with the present invention.

FIG. 7 is a flow diagram illustrating the different stages of processing for embedding a television video image within an HTML Web page in accordance with the present invention.

FIG. 8 is a program listing in pseudo code illustrating an HTML extension used for embedding a television image object in a Web page.

### DETAILED DESCRIPTION

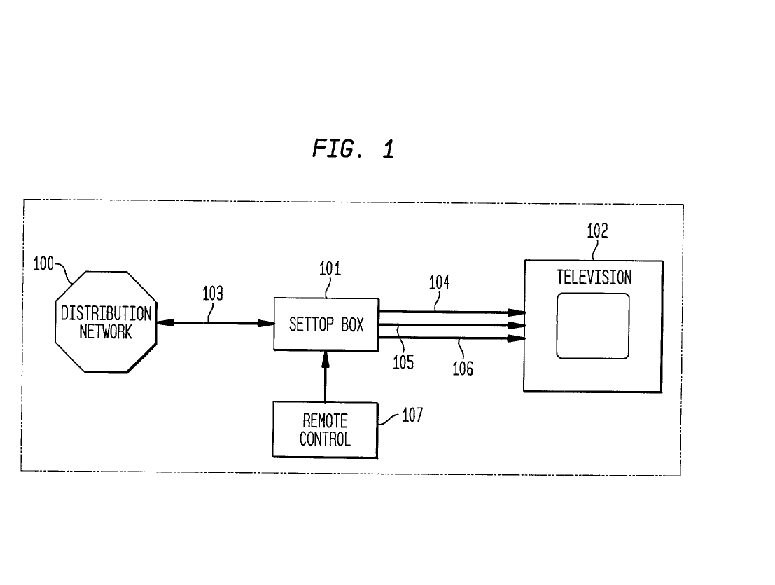

A television video and data display system for use with the present invention is shown in FIG. 1. A distribution network 100 broadcasts television video and World Wide Web data to a plurality of settop boxes 101 for display on individual television sets 102. The distribution network 100 may be any suitable broadband medium such as wired coaxial cable or fiber optic cable or a wireless broadband medium such as direct satellite broadcast or terrestrial transmission. The settop box 101 provides video 104 and audio 105, 106 signals to the television display 102.

The settop box 101 stores a software module (the client software) downloaded from the distribution network 100. The client software runs locally on the settop box 101 and performs the following functions.

1) Obtains World Wide Web content and television programming content from the distribution network 100.

2) Interprets the relationship of the World Wide Web content to the television video.

3) Generates a composite display of integrated television video and graphics in the settop box 101 for display on the television 102.

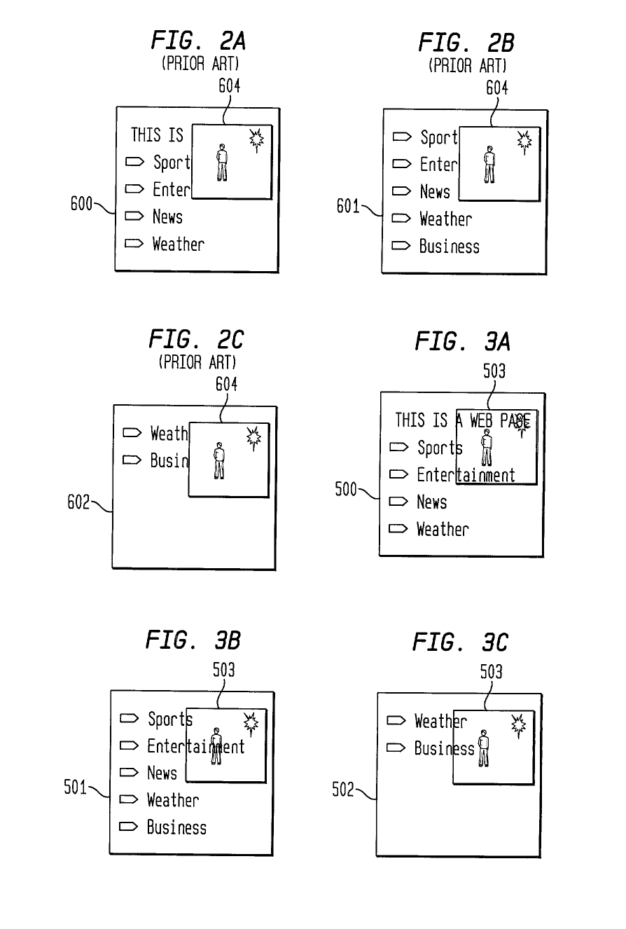

In the prior art, it is known to combine a television video image with a Web page by a Picture-In-Picture overlay in the foreground with a World Wide Web page as the background. The behavior of the combined PIP/background image is illustrated in FIGS. 2A-2C. In FIG. 2A, an opaque television video image 604 is in the foreground overlaid on Web page 600, partially obscuring the underlying Web page 600. As the Web page is scrolled upward 601 in FIG. 2B the opaque television video image 604 obscures a different portion of the underlying Web page background. As the viewer continues to scroll the Web page upward 602 in FIG. 2C the opaque television video image 604 obscures yet a different portion of the underlying Web page background. Thus, in order to view all of the Web page 600 while having a television video image in a Picture-In-Picture overlay 604, the viewer must scroll the background Web page vertically 601, 602 (or pan horizontally) out from under the overlaid television video image 604.

FIGS. 3A-3C illustrate a display in accordance with the present invention. In FIG. 3A, the viewer has control over the transparency of the television video image 503. Transparent (or translucent) television video image 503 is in the foreground, overlaid on Web page 500. By being transparent, television video image 503 does not obscure Web page 500. As the Web page is scrolled upward 501 in FIG. 3B, the transparent television video image 503 permits the user to view a different portion of the Web page 500 without obscuring the portion of the Web page underlying the television video image. As the user further scrolls the Web page upward 502 in FIG. 3C, the transparent television video image 503 always permits the user to view the portion of the Web page background underneath the television video image 503. Thus, the user can view the Web page through the television video image in a Picture-In-Picture overlay, either while the Web page is stationary or while the viewer scrolls the Web page past the transparent television video image.

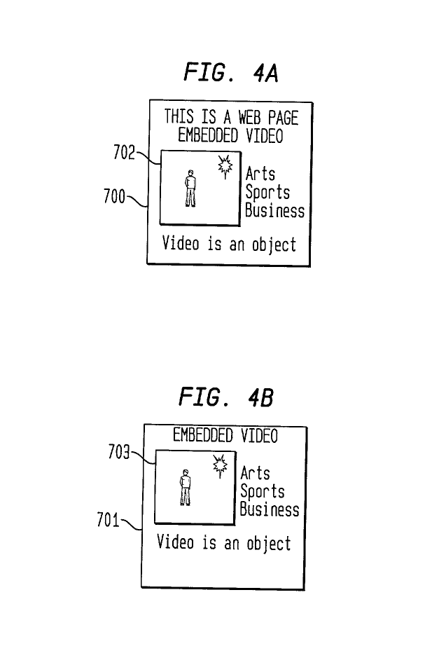

An alternative to the use of transparency to prevent an overlaid television video image from obscuring an HTML web page, is shown in FIGS. 4A and 4B. That is, FIGS. 4A and 4B illustrate a display in accordance with an alternate embodiment of the present invention. In FIG. 4A, a television video image 702, 703 is embedded as an object in a Web page 700. When the Web page is scrolled upward 701 in FIG. 4B, the embedded television video image 703 also scrolls upward. By placing (embedding) the television video image 702, 703 as an object (and therefore in an unused portion) of the Web page 700 701, the television video image 702 does not obscure the Web page 700, 701.

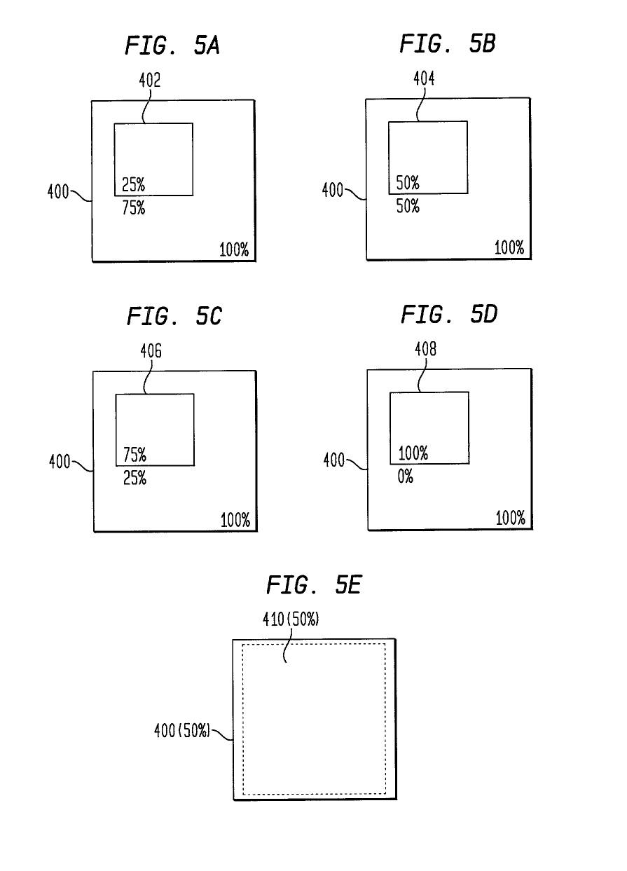

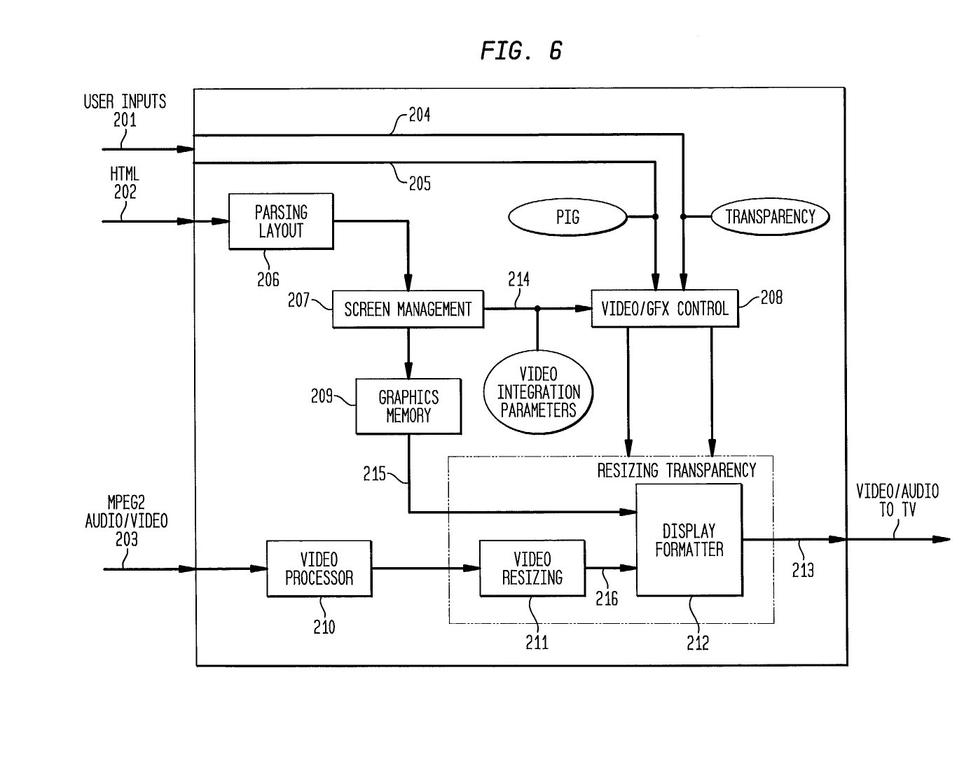

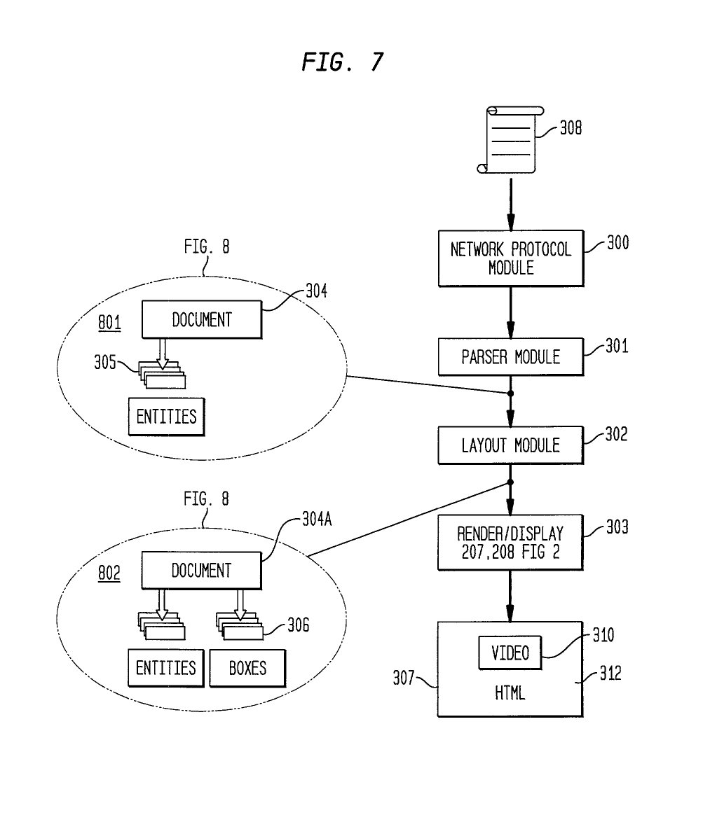

FIGS. 5A-5E show different modes of operation based on viewer control over the size, position and degree of transparency (or level of translucency) of the Picture-In-Graphics (PIG) television video image. In FIGS. 5A-5E Web page 400 occupies the full television screen with an overlaid PIG image window (402, 404, 406, 408, 410). In FIG. 5A, the PIG image window 402 is overlaid on Web page 400. The Web page region 400 outside of PIG image 402 is opaque (100% weighting). The PIG window 402 is a digital television video image, which is made translucent with the Web page. Specifically, each of the pixels in television video image 402 are weighted 25% from video and 75% from the Web page, which results in a very transparent television video image 402 on the underlying Web page 400.

The translucency values are selectable, and any value may be used for the weighting factor. For example, in FIG. 5B, each pixel in television video image 404 is weighted 50% from video and 50% from the Web page, which results in a moderate transparency in which the television video image 402 and the Web page 400 are equally weighted. In FIG. 5C, each pixel in television video image 406 is weighted 75% video and 25% Web page, which results in a slightly transparent television video image 402 on the underlying Web page 400. If, as in FIG. 5D, each pixel in television video image 408 is weighted 100% video and 0% Web page, the television video image 408 PIG IMAGE becomes opaque.

Background and foreground are relative terms with respect to transparency. If the video and Web page pixels are weighted 75/25 as in FIG. 5C, the video is in the foreground and the Web page is in the background. If the video and Web page are weighted 25/75 as in FIG. 5A, the video is in the background and the Web page is in the foreground. If the video and Web page pixels are equally weighted 50/50, neither is background or foreground. As transparency values for the video and the Web page are changed from 50/50, one becomes background and the other becomes foreground.

The PIG image window may also occupy the full screen, allowing mixing of a full screen television video image 410 with a full screen Web page 400, as shown in FIG. 5E. In FIG. 5E, the pixels in the full screen television video image 410 are weighted 50% video and 50% Web page. The full screen television video image 410 is also used with the different levels of translucency between the television video 410 and the Web page 400.

A block diagram of a display generator for embedding television video within a Web page is shown in FIG. 6. The inputs to the display generator are MPEG audio and video 203, HTML web data 202 and user control inputs 201. The output of the display generator is the composite video and audio output 213 to the television display.

The display generator comprises a parsing and layout engine 206 coupled to a screen management module 207 which is further coupled to a video and graphics (GFX) control engine 208. A graphic memory 209 stores the rendered graphics output from the screen management module 207 corresponding to the HTML 202 input graphics and text.

A video processor 210 is provided to decode the received MPEG input signal 203. The output of the video processor 210 is coupled to a video resizing module 211. A display formatter 212 is responsive to the video resizing module 211, the graphics memory 209 and the resizing and transparency controls from the Video/GFX control engine 208.

In operation, the parsing and layout engine 206 conditions the HTML data for display on a television screen and extracts the specific video related information from the HTML source 202. The output of the parsing and layout engine 206 is fed to the screen management module 207 that renders the Web page in the graphics memory 209. The screen management module 207 forwards video integration parameters to the Video/GFX graphics) control engine 208.

The Video/GFX control engine 208 takes the user inputs 201, which consist of Picture-In-Graphics (PIG) controls 205 and transparency controls 204. PIG image controls 205 determine desired size and position for the inserted Picture-In-Graphics. Transparency controls 204 relate to the degree of transparency for the inserted Picture-In-Graphics. The PIG image controls 205 and transparency controls 204 control the Display Formatter 212 and the video resizing engine 211 in accordance with the video integration parameters 214 that were extracted from the incoming HTML source 202 by the screen management module 207.

The MPEG Audio/Video compressed stream 203 is routed to the video processor 210 for decoding. The Video Resizing module 211 is responsible to resize the video in real time (on the fly). The display formatter module 212 and the video resizing module 211 allow flexible combinations of graphics data 215 and real time video stream data 216 to form a various Picture In Graphics (PIG) and transparency combinations at the output 213, as illustrated in FIGS. 3A-3C, 4A, 4B and 5A-5E.

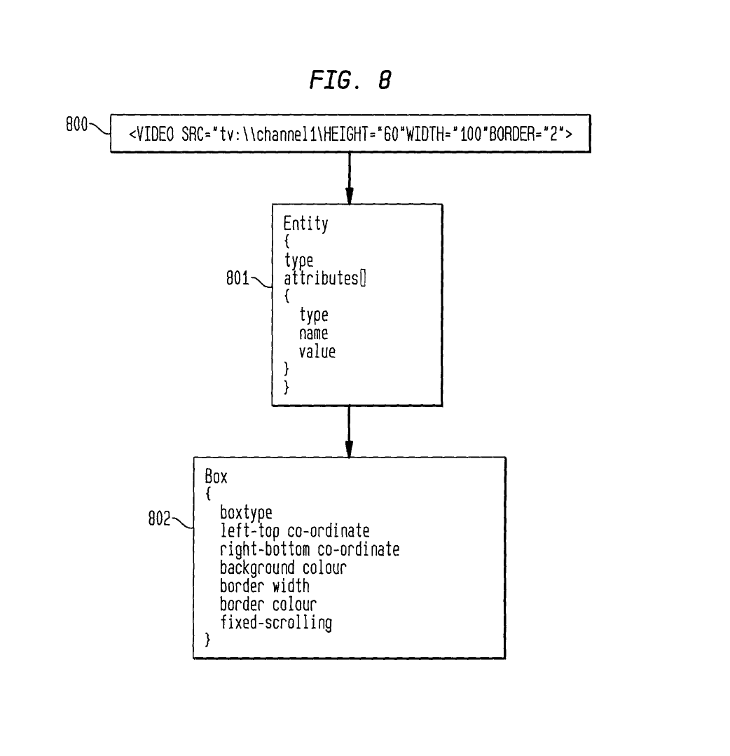

The display behavior and integration of Web content and television video is controlled by the incoming HTML 202 source. With the present system, the author of a Web page using a markup language like HTML can integrate television video with Web based text and graphics together to create a compelling user interface on a television screen. The markup language tag for the video (800 in FIG. 8) controls the display position, style and behavior of the video embedded within the Web page on the settop box.

An HTML scheme to specify television video and Web data integration is illustrated in FIGS. 7 and 8. In FIG. 7, the settop box downloads a markup language page 308 from the network and processes it to determine the position, size and other attributes of the television video along with the display attributes for text and graphics in the Web page content. The whole processing of the markup language page 308 is done in software in various modules illustrated in FIG. 7.

Following steps comprise the process:

Step 1: The Network protocol module 300 of the software downloads the Markup Language file 308 through a network connection from a remote host.

Step 2: The information downloaded from the network is passed to the parser module 301 which parses the markup language based on a predetermined syntax and grammar and separates all the markup tags, attributes associated with the tags and the data information. Based on the tags parsed from the page, the parser 301 builds a logical structure for the document 304 and all the entities 305 (see 801 in FIG. 8) that consists of the document 304. The television video, which is treated as an entity, is also constructed based on the video tag as specified in the markup language. For illustration, the syntax for specifying the video entity in the markup language is as follows:

<VIDEO SRC=“Source:Frequency:ChannelNo” HEIGHT=“in graphical units” WIDTH=“in graphical units” BORDER=“in graphical units”>

Where

SRC—specifies the source for the video. The source for the video could specified by the frequency to which the settop box tuner needs to be tuned and/or the user perceived channel number that the user selects.

HEIGHT—height of the video region to be displayed.

WIDTH—width of the video region to be displayed.

BORDER—border around the video region.

<HEAD>

<PIGPOS>

<PIG X=”X position on the display absolute coordinate” or X=“X position in % of display width” Y=” Y position on the display absolute coordinate “or Y=”Y position in % of display height” RATIO or WIDTH=“ ” HEIGHT=“ ”>

</PIGPOS>

</HEAD>

The document 304 thus constructed at end of the parsing stage 301 is then passed to the next stage of processing for calculation of all the physical attributes required to display the document on television monitor.

Step 3: The structured document/entity representation of the page is next processed by the layout module 302 that decides the position, look and feel of each entity 305 within the Web page which comprise of either television video, text or graphics. The position information and other display attributes such as color, border etc. for each entity are represented in a logical structure called a box 306 (see 802 in FIG. 8). The box created contains all the information, necessary and required by the render/display module 303, to render the entity on the screen. The document now has a list of boxes 306 including a video box for the television video, that has the dimensions and display attributes according to the intent of the content author. Each box has a box type associated data field to distinguish it as being a box for text, a box for graphics or a box for television video.

Step 4: The render and display module 303 takes the list of boxes 306 within the document 304A as its input and renders all the boxes, one by one, into the display buffer (209 in FIG. 6). The render/display module 303 in FIG. 7 encompasses the functions of screen management 207 and video/GFX control 208 in FIG. 6. When the display module encounters a video type box in the document, the display module (208 in FIG. 6) switches to the appropriate real time video source. The television video 310 is merged on the fly with the Web graphics and text 312 for an integrated look and feel.

Several modes of operation are supported:

MODE 1—Full screen transparent Web page with full screen transparent television video.

Full screen mode is shown in FIG. 5E. The Web page 400 occupies the entire resolution of the television screen and is transparent allowing the viewer to see the full screen television video 410. The transparency values are shown as 50% for the Web page 400 and 50% for the television video 410. Since the Web page 400 and the television video 410 are of equal weight neither can be considered background or foreground. However, the transparency values for television video versus Web page are adjustable by the user. The viewer can fade either one so as to put the Web page in the foreground and the television video in the background, or vice versa.

MODE 2—Full screen Web page background with transparent television video in non-embedded overlaid Picture In Graphics (television video overlay which does not scroll with Web page background)

Overlay mode with transparency control is shown in FIGS. 3A, 3B and 3C. The Web page 500 occupies the entire resolution of the television screen and is opaque. The broadcast television video is resized in a translucent (PIG) Picture-In-Graphics box 503. (The PIG image may be opaque as in FIGS. 2A-2C). The PIG image is positioned as an overlay on top of the Web page and its position and size are independent of the Web page in the background. As shown in figures, scrolling the Web page 500, 501 and 502 in FIGS. 3A, 3B and 3C respectively does not change the PIG image 503 position or its size on the television screen.

MODE 3—Full screen Web page opaque with embedded television video Picture-In-Graphics (television video overlay which scrolls with Web page background)

Embedded mode is shown in FIGS. 4A and 4B. The Web page 700 occupies the entire resolution of the television screen and is opaque. The broadcast television video is resized in a Picture-In-Graphics box 702, 703 and is embedded in the Web page 700, 701. The PIG image 702, 703 is integral part of the Web page like any other asset, such as text, images, tables and the like. When the Web page 700, 701 scrolls (vertical screen movement and/or pans (horizontal screen movement, the television video PIG image 702, 703 will move as well in order to keep its relative position in the Web page 700, 701.

What is claimed is:

1. A display generator for a combined display of a graphics image and a television video image, said graphics image being defined by an HTML syntax, said television video image being derived from a real time television signal, said display generator comprising:
a programmed processor responsive to said HTML syntax for parsing, layout and rendering said graphics image to form a rendered graphics image;
a graphics memory for storing said rendered graphics image;
a television video receiver responsive to said real time television signal, said television video receiver having an output forming said television video image; and
a video combiner responsive to said graphics memory and said television video receiver for combining individual pixels of said rendered graphics image stored in said graphics memory with respective individual pixels of said television video image to form respective individual pixels of said combined display of said graphics image and said television video image.

2. A display generator in accordance with claim 1, further including a transparency control input terminal, wherein said video combiner is responsive to said transparency control input to form individual pixels of said combined graphics image and said television video image from individual pixels of said rendered graphics image stored in said graphics memory with respective individual pixels of said television video image in a proportion determined by a control signal applied to said transparency control input terminal.

3. A display generator in accordance with claim 1, further including a size control input terminal, wherein said video combiner further comprises:
a video resizing module having a respective input terminal coupled to said television video receiver and respective output terminal coupled to said video combiner, said video resizing module responsive to a size control input to scale said television video image by a factor determined by said size control input.

4. A display generator in accordance with claim 3, further including a position control input, wherein said video combiner is responsive to said position control input to form individual pixels of said combined graphics image and television image by combining individual pixels of said rendered graphics image stored in said graphics memory with individual pixels of said television video image at a position determined by said position control input.

5. A display generator for a combined display of a graphics image and a television video image, said graphics image being defined by an HTML syntax including a television video HTML statement defining a television video HTML object, said television video image being derived from a real time television signal, said display generator comprising:
a television video receiver responsive to said real time television signal, said television video receiver having an output forming said television video image;
a programmed processor responsive to said HTML syntax for parsing, layout and rendering said graphics image to form a rendered graphics image,
a graphics memory for storing said rendered graphics image;
a video combiner responsive to said graphics memory and said television video receiver to combine individual pixels of said rendered graphics image stored in said graphics memory with respective individual pixels of said television video image, said video combiner further responsive to said television video HTML statement to position said television video image in said graphics image to form said combined display.

6. A display generator in accordance with claim 5, wherein said television video receiver is responsive to said television video HTML statement to determine the channel selected by said television receiver.

7. A display generator in accordance with claim 5, wherein said video combiner is responsive to said television video HTML statement to determine the size of said television video HTML object in said rendered graphics image.

8. A display generator in accordance with claim 5, wherein said video combiner is responsive to said television video HTML statement to determine the position of said television video HTML object in said rendered graphics image.

9. A display generator in accordance with claim 5, wherein said television video HTML statement is substantially given by
<VIDEO SRC=“Source:Frequency:ChannelNo” HEIGHT=“in graphical units” WIDTH=“in graphical units” BORDER=“in graphical units”>, wherein,
SRC specifies the source as the Frequency or Channel Number of said real time television signal,
HEIGHT specifies the height of said television video HTML object to be displayed,
WIDTH specifies the width of said television video HTML object to be displayed and
BORDER specifies the border around said television video HTML object to be displayed.

10. A method for generating a combined display of a graphics image in combination with a television video image, said graphics image being defined by an HTML syntax, said television video image being derived from a real time television signal, said method comprising:
rendering said HTML syntax to form a rendered graphics image;
receiving said real time television signal to form said television video image;
combining individual pixels of said rendered graphics image with respective individual pixels of said television video image to display respective individual pixels of said rendered graphics image in combination with said television video image.

11. A method in accordance with claim 10, further including the step of controlling the relative transparency of said graphics image in combination with said television video image by combining said individual pixels of said rendered graphics image and said respective individual pixels of said television video image in a predetermined ratio.

12. A method for generating a combined display of a graphics image in combination with a television video image, said graphics image being defined by an HTML syntax including a television video HTML statement defining a television video HTML object, said television video image being derived from a real time television signal, said method comprising:
receiving said real time television signal to form said television video image;
rendering said HTML syntax to form a rendered graphics image;
combining, responsive to said television video HTML statement, individual pixels of said television video image with respective individual pixels of said rendered graphics image, to position said television video image in said graphics image and form said combined display.

13. A method in accordance with claim 12, wherein said receiving step is responsive to said television video HTML statement to determine the channel of said television video image.
